(19) United States
(12) Patent Application Publication
(10) Pub. No.: US 2004/0103068 A1
(43) Pub. Date: May 27, 2004

(54) Process for optimally operating an energy producing unit and an energy producing unit

(76) Inventors: Sukru Alper Eker, Guilderland, NY (US); Srinivas Bollapragada, Niskayuna, NY (US)

Correspondence Address: PHILIP D. FREEDMAN, PHILIP D. FREEDMAN PC, P. O. BOX 19076, ALEXANDRIA, VA, 22320, US

(21) Appl. No.: 10/301,693

(22) Filed: Nov. 22, 2002

(51) Int. Cl. G06F 17/60

(52) U.S. Cl. 705/412; 705/1

(57) ABSTRACT

A predictive control process comprises determining a firing temperature profile that maximizes profit from a summation over a period of time of a difference between return from operation of the energy producing unit and cost of operating the energy producing unit, wherein the cost includes at least one non-linear variable and at least one value for the non-linear variable is provided from a data model; and operating the energy producing unit according to a firing temperature profile derived from the optimized profit. An optimally operated energy producing unit comprises (A) a combustor, and (B) a controller that regulates firing temperature of the combustor for a time period, wherein a firing temperature is determined as an inverse function of a factored hour associated with an optimal profit for the time period; wherein the optimal profit is determined as a summation over a period of time of a difference between return from operation of the energy producing unit and cost of operating the energy producing unit, wherein the cost includes at least one non-linear variable and at least one value for the non-linear variable is provided from a data model.

### BACKGROUND OF THE INVENTION

The invention relates to a predictive control process for optimally operating an energy producing unit and an optimally operated unit.

Energy producing units can include gas turbines that are used as a power source or a part of electrical generating equipment. A combustion type gas turbine has a gas path that typically includes, in a serial-flow relationship, an air intake (or inlet), a compressor, a combustor, a turbine, and a gas outlet (or exhaust nozzle). Control of the power generated by the gas turbine is typically exercised through control of fuel flow and air flow into the combustor.

Efficient operation of the gas turbine engine is important to maximized profit and to reduce noxious emissions. Typically, efficient operation is determined by fuel economy and emission control. For example, a typical objective has been to establish and maintain a desired stable power output within defined limits and to reduce the level of emissions by controlling a number of turbine operating parameters, such as fuel flow, distribution and air flow intake.

Parts life and maintenance costs are other important cost factors in turbine engine operation. Competition in the electricity generation market and fluctuations in electricity prices and fuel cost have increased the importance of these factors for establishing optimal turbine engine operation. Some studies have been conducted on understanding the different operation modes of gas turbines relative to maintenance considerations. For example, gross gas turbines parts-life models have been developed for operation control and maintenance scheduling. Firing temperature, fuel type and steam/water injection for power augmentation have been identified as factors that influence parts life and maintenance. However, while it is known grossly that higher levels of production can be achieved by applying a higher firing temperature at the expense of parts life and increased maintenance cost, the relationships among these factors are not known. There remains a need to determine the relationships between higher production level and parts life and maintenance requirements for determining optimal engine operation. There is a need to determine operating parameters for optimizing an energy producing unit profit performance.

### BRIEF DESCRIPTION OF THE INVENTION

The present invention relates to a predictive control process for optimally operating an energy producing unit and an optimally operated energy unit. In the invention, a predictive control process is provided for optimally operating an energy producing unit. The process comprises determining a firing temperature profile that maximizes profit from a summation over a period of time of a difference between return from operation of the energy producing unit and cost of operating the energy producing unit, wherein the cost includes at least one non-linear variable and at least one value for the non-linear variable is provided from a data model; and operating the energy producing unit according to a firing temperature profile derived from the optimized profit.

In an embodiment of the invention, a predictive control process for controlling operation of a turbine engine through actuators that have a defined constraint set according to profit determined from a plurality of power output states and operating cost states comprises (A) constructing a data base by determining a plurality of profit per factored hour relationships for incremental time intervals based on models defined by a relationship:

Prfᵢ(Pᵢqᵢ(fᵢ)−C^{f}F_{flow}(fᵢ)−C^{m}fᵢ−Cᵢ^{o})

where Prfᵢ is profit in period i; Pi is price per mega watt hour in period i; qᵢ is mega watt hours produced in period i; fᵢ is factored hours spent in period i; C^{f} is fuel cost per lb of fuel used; F_{flow} is fuel spent in period i; C^{m} is maintenance cost per factored hour and Cᵢ^{o} is other operating costs incurred in time period i; and further where at least one data model value is substituted for an operating cost value in the relationship to transform the solution of the relationship to a linear problem solution; (B) calculating changes in profit from one incremental time interval to a next for the plurality and calculating changes in factored hours from the incremental time interval to the next for each associated profit change; (C) identifying a maximum change in profit from the calculated changes for the plurality; (D) determining a firing temperature profile from an inverse function of a factored hour change associated with the identified profit change; and (E) adjusting the actuators according to the firing temperature profile to control the turbine engine to optimize profit.

In another embodiment, an optimally operated energy producing unit comprises (A) a combustor, and (B) a controller that regulates firing temperature of the combustor for a time period, wherein a firing temperature is determined as an inverse function of a factored hour associated with an optimal profit for the time period; wherein the optimal profit is determined as a summation over a period of time of a difference between return from operation of the energy producing unit and cost of operating the energy producing unit, wherein the cost includes at least one non-linear variable and at least one value for the non-linear variable is provided from a data model.

In still another embodiment. a controller for determining an optimal profit for a time maintenance interval and actuating an energy producing unit according to operational parameters comprises a computer readable medium having a computer program stored thereon; the computer program being adapted to summing over a period of time a difference between return from operation of the energy producing unit and cost of operating the energy producing unit to provide a firing temperature profile, wherein the cost includes at least one non-linear variable and at least one value for the non-linear variable is provided from a data model; and an actuator operating the energy producing unit according to the firing temperature profile

### BRIEF DESCRIPTION OF THE DRAWING

FIG. 1 shows profit curves for short time periods throughout an entire future time;

FIG. 2 is a schematic elevation view of a controlled gas turbine engine; and

FIG. 3 is a schematic flow diagram of operation of a profit optimizer.

### DETAILED DESCRIPTION OF THE INVENTION

A gas turbine engine can be operated in accordance with the invention to maximize power utility profits in an environment of fluctuating energy prices. Adjusting the firing temperature of a gas turbine varies its power output. The firing temperature also affects turbine part wear and tear and correspondingly determines intervals between turbine maintenance. According to the invention, the firing temperature of a gas turbine is determined to maximize profit generated from sales of electricity. In one embodiment, profit is maximized over a user determined interval and in another embodiment, a profit is determined for a time maintenance interval.

In this specification, “profit” is return over expenditure. Profit for a gas turbine engine can be expressed as a summation over a period (i) of a difference between return and costs. Return can be expressed as the product of megawatt hour price (Pᵢ) and megawatt hours produced (qᵢ) by a turbine engine and costs can be expressed as fuel cost, maintenance cost and another operating cost. Fuel cost can be expressed as a product of fuel cost per lb of fuel and fuel spent in a period; maintenance cost can be expressed as a product of maintenance cost per a hour and hours in a period and other operating cost can be expressed as a product of other cost incurred per lb of fuel and fuel spent in the period. A maximized profit relationship can be expressed algorithmically as (1).

$$\begin{matrix}Maximized Pr f = {\sum }_{i = 1}^{T} ( {P}_{i} {q}_{i} ( {t}_{i} ) - {C}^{f} {F}_{f low} ( {t}_{i} ) - {C}^{m} {f}_{i} ( {t}_{i} ) - {C}_{i}^{o} ) \\ With respect to {t}_{i} \\ Subject to {\sum }_{i = 1}^{T} {f}_{i} ( {t}_{i} ) = F {ω}_{i} ( {t}_{i} ) \leq {Ω}_{i} i = 1 , … , T\end{matrix} \qquad ( 1 )$$

The following notation applies in (1) and throughout this specification:

N=Number of long time periods (weeks, months, years) before a next inspection

τ=time period (resolution of a future horizon time period)

T=Number of shorter time periods i until a next inspection (hours, days)=function(N,τ) (e.g. if N=52 weeks, and τ=6 hours, T=52*7*24/τ=1456)

i=index for period

tᵢ=Firing temperature in period i

mᵢ=Maintenance factor in period i

fᵢ=mᵢτ=Factored hours spent in period i, where Factored hours are defined as life spent of a gas turbine when the gas turbine is fired for an actual hour. A Factored hour is a nonlinear function of firing temperature.

qᵢ=Mega Watt hours (MWH) produced in period i

ωᵢ=NOₓ produced in period i

F=Total number of factored hours left before next inspection

C^{m}=Maintenance cost per factored hour

C^{f}=Fuel cost per lb of fuel used

F_{flow}=Fuel spent in period i

Cᵢ=Other operating costs incurred in time period i

Ωᵢ=Limit on NOₓ produced in period i

Pᵢ=Price per MWH in period i

Prf=Profit obtained from sales of electricity produced with operational costs (fuel cost and maintenance cost for the operation of gas turbines) and fixed costs

If N is fixed by a user, then the objective is to maximize profit in that time interval, if not fixed, then an objective is to find both firing temperature and N that maximize average profit per interval ($/weeks, months) as in formulation (2)

$$Maximized Prf = maximized {\sum }_{i = 1}^{T} ( {P}_{i} {q}_{i} ( {t}_{i} ) - {C}^{f} {F}_{f low} ( {t}_{i} ) - {C}^{m} {f}_{i} ( {t}_{i} ) - {C}_{i}^{o} ) / N \\ \begin{matrix}With respect to {t}_{ i} , N \\ Subject to {\sum }_{i = 1}^{T} {f}_{i} ( {t}_{i} ) = F {ω}_{i} ( {t}_{i} ) \leq {Ω}_{i} i = 1 , … , T\end{matrix} \qquad ( 2 )$$

Formulation (1) can be solved for different N values according to (2) to find turbine engine optimum maintenance intervals. The formulations can be used in a Model Predictive Control (MPC) system to optimally control gas turbine engine operation. MPC is a system of control algorithms that use process models to compute a sequence of manipulated variables for on-line optimization of a future process behavior. MPC can be used to predict how a process will evolve in time. This prediction can be used to determine optimal control moves that will steer the process to a desired steady state. An MPC system uses a process model to predict the future state of a process variable to be controlled, and then to manipulate one or more process inputs (controller outputs) to minimize expected error between the prediction and the set points.

In MPC, a process is modeled with a step or impulse response vector of the process. The model predicts one or more process outputs from process inputs and the optimum controller response is computed by means of linear optimization of a series of controller inputs. This on-line optimization is solved at each sampling time using a current state of a process as an initial state. Only a first control move of the optimal sequence is applied to the process. The MPC procedure is repeated at each sampling time to determine each next optimal sequence.

Certain problems are encountered with the use of formulations (1) and (2) in MPC systems. Factored hours are a finite number. Hence, one problem is to determine how to allocate the total Factored hours optimally for maximum profit. The limit on the Factored hours that can be spent in future time horizon N is a first constraint in formulation (1). This constraint is a nonlinear equality constraint. NOₓ emission levels comprise a second constraint—a nonlinear inequality constraint. Hence, formulation (1) and formulation (2) both are non-linear, non-convex optimization problems Non-linearity substantially extends computation time thereby depreciating the value of an MPC to control an on-line energy producing unit such as a gas turbine. For example, it takes approximately 2 days to produce a firing temperature profile with an MPC optimizer resident in a Pentium III processor based on formulations (1) and (2) with assumptions that firing temperature is kept constant for τ=a 12 hour period, resulting in T=60 variables provided an N=30 day.

According to an embodiment of the invention, non-linearity is avoided by using data model values for the non-linear function. For example, non-linear optimization is avoided by using factored hour values derived from model firing temperature values. In this specification, a data model is a predictive data representation of a physical system based on empirically generated information or based on predicted information generated according to specified conditions such as the laws of physics. A parts life model is an example of a data model. A parts life model is one of various models developed by plant operators for gas turbine engine operation to focus on engine operation modes and engine maintenance. The models reflect empirical information that typically is nonlinear. The models can provide firing temperature, fuel type and steam/water injection information for power augmentation. For example, parts-life models can be used to transform firing temperatures to factored hours. A part life model may indicate that each hour at peak load firing temperature operation is the same to a bucket parts life as six hours of operation at a base load. Another model may show relationships among emission levels, parts-life and a maximized profit megawatt (MW) production. Another model includes operating revenue information (qi(fi). The product of (qi(fi) and (Pi) is operating revenue. Another model can relate level of MW production, emissions and spent part-life according to inputs such as firing temperature, ambient temperature, etc.

In formulation (1), independent variables are firing temperatures at each step. In another embodiment of the invention, factored hours are taken as the optimization decision variables. In this embodiment, the problem turns into a resource allocation problem as in formulation (3).

$$Maximize Prf = {\sum }_{i = 1}^{T} ( {P}_{i} {q}_{i} ( {f}_{i} ) - {C}^{f} {F}_{f low} ( {f}_{i} ) - {C}^{m} {f}_{i} - {C}_{i}^{o} ) \\ \begin{matrix}With respect to {f}_{i} \\ Subject to {\sum }_{i = 1}^{T} {f}_{i} = F\end{matrix} \qquad ( 3 )$$

Factored hours are life spent of a gas turbine when the gas turbine is fired for an actual hour. A factored hour is a nonlinear function of firing temperature. Since total factored hours is a finite number, one problem is to determine how to allocate the total factored hours optimally for maximum profit. For example, contrary to Formulation (3), it might be sometimes better not to spend a factored hour when the marginal cost of spending the factored hour exceeds the revenue obtained by spending that factored hour. This leads to slightly different formulation (4).

$$Maximized Prf = {\sum }_{i = 1}^{T} ( {P}_{i} {q}_{i} ( {f}_{i} ) - {C}^{f} {F}_{f low} ( {f}_{i} ) - {C}^{m} {f}_{i} - {C}_{i}^{o} ) \\ \begin{matrix}With respect to {f}_{i} \\ Subject to {\sum }_{i = 1}^{T} {f}_{i} \leq F\end{matrix} \qquad ( 4 )$$

where the only difference is that all of the factored hours does not need to be spent as the inequality constraint dictates.

According to an embodiment of the invention, the formulations (3) and (4) are solved iteratively as follows:

In a first step, a data base is constructed by determining a plurality of profit per factored hour relationships for incremental time intervals based on models defined by a relationship:

Prfᵢ(Pᵢqᵢ(fᵢ)−C^{f}F_{flow}(fᵢ)−C^{m}fᵢ−Cᵢ^{o})

where Prfᵢ is profit in period i; Pi is price per mega watt hour in period i; qᵢ is mega watt hours produced in period i; fᵢ is factored hours spent in period i; C^{f} is fuel cost per lb of fuel used; F_{flow} is fuel spent in period i; C^{m} is maintenance cost per factored hour and Cᵢ^{o} is other operating costs incurred in time period i. The solution for the maximized profit for the whole time horizon covering the number of short term intervals, T can be solved as a linear problem (by linear programming) with in this formulation.

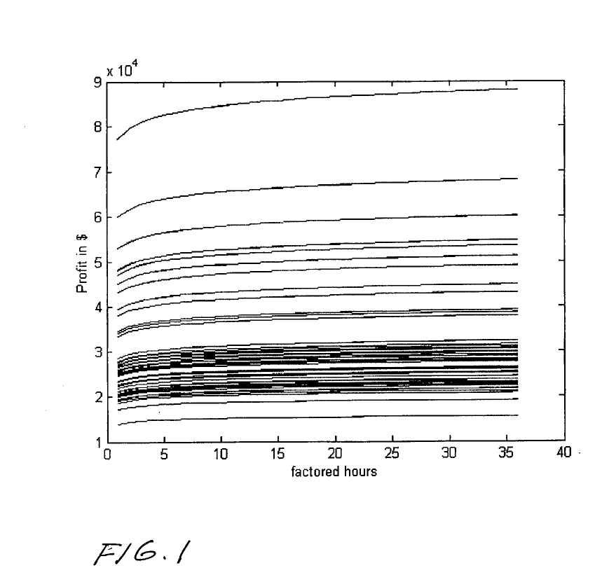

The data base of this step can be visualized as a plurality of profit curves for i=1 to T (from step 1 to the end of horizon) as depicted as in FIG. 1 or as a profit table of T number of rows and (\overline{f}ᵢ−fᵢ)/Δf number of columns. The data base is constructed according to the following steps:

(i) Find fᵢ by a minimum production requirement (dictated by contracts on the power utility plant) from a gas turbine cycle performance model by numerical inversion, \overline{f}ᵢ from NOₓ emission constraint with the same method for i=1 to T.

(ii) Input ambient temperature, electricity price and fuel cost price for the index i

for fᵢ=fᵢ to \overline{f}ᵢ by step Δf

(iii) Convert fᵢ to tᵢ by applying the inverse function relation of the parts life model

(iv) Determine qᵢ(tᵢ) from a gas turbine performance data model such as a parts life model or a cycle-deck model. For example, ambient temperature and firing temperature are entered into the model and relatable qᵢ(tᵢ) values are “read out.”

(v) Calculate Prfᵢ=(Pᵢqᵢ(fᵢ)−C^{f}F_{flow}(fᵢ)−C^{m}fᵢ−Cᵢ^{o}) for a plurality of time periods.

This procedure provides data for a profit data base that can be represented by the FIG. 1 profit curves. The data base can be combined to allow solving for a maximized profit over the longer time period, N, according to a second set of steps as follows:

(1) Discretizing the data. Discretization divides the numeric data into intervals, creating “string” values for the attribute that then can be compared. Dividing the data into intervals makes the data analysis more robust and easier to understand. In this step, change in profit with change in variables is determined for each incremental periods τ to provide a discretized data base of ΔPrf (change in profit) values with respect to Δ factored hours. This table has T number of rows and (\overline{f}ᵢ−fᵢ)/Δf−1 columns. The discretized data base enables comparison of increased in profits for the short time periods i, for all periods in the future according to next step (2).

(2) Identifying a maximized change in profit from the calculated changes (ΔPrf) of the discretized data base.

(3) After identifying the maximized change in profit from the data base, a firing temperature profile is determined from an inverse function of a factored hour change associated with the identified maximized change in profit according to a data model. For example, the factored hours can be transformed to firing temperatures by the inverse functions of the part-life model. For example according to a parts life model, for τ=a 6 hour time interval, factored hours change from 1 to 36 if temperature deviation from a base load temperature is taken as −100 to 100. According to the model, a factored hour of 36 corresponds to a firing temperature of +100 from baseline temperature.

If formulation (3) is solved, then steps (2) and (3) are repeated by sequentially identifying a next maximized profit and determining a firing temperature profile from the associated next maximized change in profit. This step is continued until all the factored hours are spent. If formulation (4) is solved, then steps (2) and (3) are sequentially repeated as long as the next identified change in profit is positive (marginal cost of firing is less than marginal profit).

(4) Implementing the firing temperature profile determined from steps (1) to (3). For example, operation of a turbine engine can be controlled through actuators that have a defined constraint set according to profit determined from steps (1) through (2) by adjusting the actuators according to the firing temperature profile determined in step (3) to control the turbine engine to optimize profit.

A firing temperature profile can be determined to the end of the horizon period T by sequentially repeating steps (1) through (3). In these steps, each next best maximized change in profit is sequentially identified and its associated factored hours are trans formed into a firing profile according to step (3) for a next sequential period τ. For example, time index i is shifted by 1 after updating the model parameters and market price information such as electricity price forecast with new available information for i=2 to T+1 as in a MPC paradigm (moving horizon).

An advantage of the invention is that steps (i) through (v) and (1) through (3) can be determined in a time period to repeatedly and timely provide firing profiles for a next time period. Hence in a preferred embodiment, a firing temperature profile for period i is determined and implemented and a new firing profile is determined at each next sequential time i+n with current model parameters and market price information.

Features of the invention will become apparent from the drawings and following detailed discussion, which by way of example without limitation describe preferred embodiments of the invention.

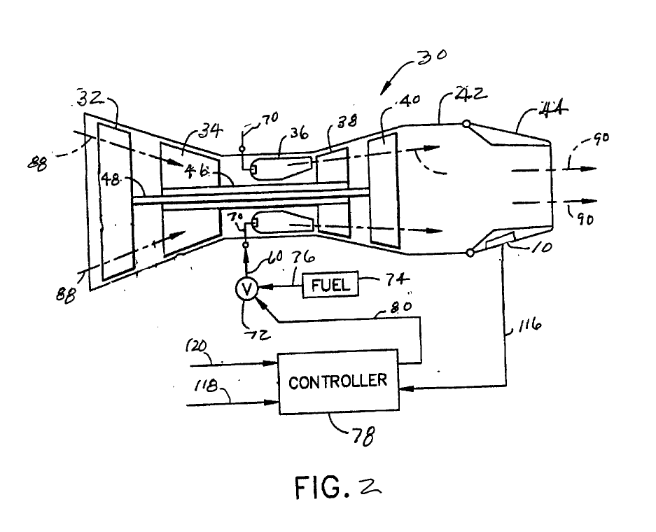

In the drawings, FIG. 2 shows an exemplary gas turbine engine 30 controlled by a firing temperature profile according to an embodiment of the invention. Turbine engine 30 is configured to include in serial flow communication: low pressure compressor 32; high pressure augmentor 42; and cooperating variable area exhaust nozzle 44. The high pressure turbine 38 is fixedly joined to the high pressure compressor 34 by core shaft 46. The low pressure turbine 40 is fixedly joined to the low pressure compressor 32 by shaft 48.

A plurality of fuel injectors 70 are mounted around the upstream inlet end of the combustor 36, disposed in flow communication with a fuel control valve 72. The valve 72 is suitably joined to a fuel tank 74, which contains a fuel that is pressurized and provided 76 to the valve 72 for metered flow to the injectors 70. The engine 30 also includes a digitally programmable controller 78, which may be a computer or the like. The controller 78 is electrically joined between a sensor 10 and fuel valve 72 for metering fuel flow 60 into the combustor 36.

In typical operation, air 88 enters the low pressure compressor 32 and is pressurized through the compressor 34, mixed with fuel 80 in the combustor 36 and suitably ignited for generating hot combustion gas 90. The hot combustion gas 90 is discharged from the combustor 36 to enter the high pressure turbine 38. High pressure turbine 38 extracts energy from the gas 90 for powering the compressor 34. Combustion gas 90 in turn flows downstream through low pressure turbine 40, which extracts additional energy from gas 90 for powering the fan of compressor 32.

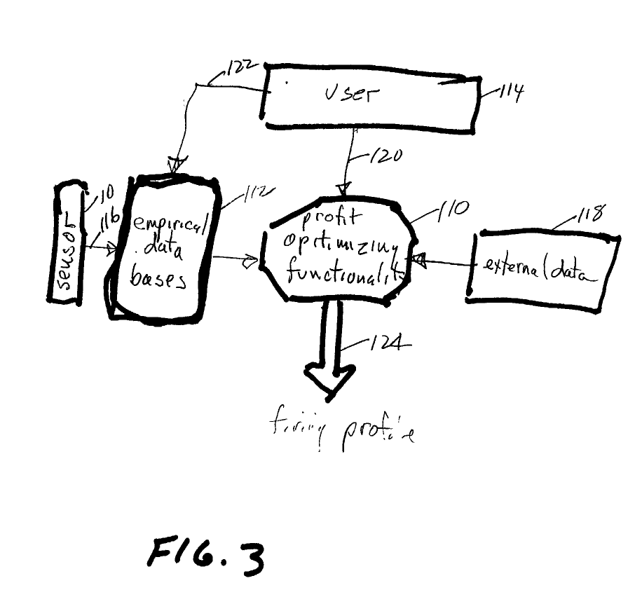

In an embodiment, controller 78 includes a profit optimizing functionality illustrated as 110 in FIG. 3. FIG. 3 is a schematic flow diagram of operation of the profit optimizing functionality 110, showing input/output relationships. As shown in FIG. 3, optimizing functionality 110 can use performance, emission and empirical data base models 112, which can be updated either by a user 114 or from sensor 10 information 116. Sensor information can be obtained for example, through sensor 10 shown in FIG. 2. Sensor 10 can be a thermocouple or the like. External data 118, such as electricity price, fuel price and ambient temperature can be user entered 120 or obtained from as associated resident data base or sensor 10. Input from user 114 can include: remaining part-life, F, future time horizon, N; a minimum MW production constraint; NOₓ emission constraint Ωᵢ; electricity price for a future time horizon; fuel price for a future time horizon; and weather information for a future time horizon.

The profit optimizing functionality 110 of the controller 78 applies the following iterative steps:

(1) Constructing a data base by determining a plurality of profit per factored hour relationships for incremental time intervals based on models defined by a relationship: Prfᵢ=(Pᵢqᵢ(fᵢ)−C^{f}F_{flow}(fᵢ)−C^{m}fᵢ−C₁^{o}). (2) Converting the data base to change in profit per factored hour by discretizing profit values. (3) Sequentially selecting factored hours associated with change in profit in descending order according to decreasing change in profit. (4) Transforming the selected factored hours to a firing temperature profile 124 according to inverse functions of a data model. (5) Firing gas turbine 30 by controlling valve 72 according to the firing temperature profile. At a next period of time, data model and other data information can be updated and the data base reconstructed to provide a basis for recalculating a current firing temperature profile 124 to control turbine 30.

The EXAMPLE illustrates one application of an optimizing process to control the operation of an energy producing unit to provide optimized profit. Optimization determinations at numerous time intervals imparts robustness to profit calculation and minimizes short term electricity price change and short term system change uncertainties such as ambient temperature change.

While preferred embodiments of the invention have been described, the present invention is capable of variation and modification and therefore should not be limited to the precise details of the Examples. The invention includes changes and alterations that fall within the purview of the following claims.

What is claimed is:

1. A predictive control process for optimally operating an energy producing unit, comprising:
determining a firing temperature profile that maximizes profit from a summation over a period of time of a difference between return from operation of the energy producing unit and cost of operating the energy producing unit, wherein the cost includes at least one non-linear variable and at least one value for the non-linear variable is provided from a data model; and
operating the energy producing unit according to a firing temperature profile derived from the optimized profit.

2. The process of claim 1, wherein the data model is a predictive data representation of a physical system based on empirically generated information or based on predicted information generated according to specified conditions.

3. The process of claim 1, wherein the value provided from a data model is a parts life model.

4. The process of claim 1, wherein return is a product of megawatt hour price and megawatt hours produced by an energy producing entity.

5. The process of claim 1, wherein cost of operating the energy producing unit is a sum of fuel cost, maintenance cost and a fixed operating cost.

6. The process of claim 1, wherein cost of operating the energy producing unit is a sum of fuel cost, maintenance cost and a fixed operating cost, wherein fuel cost is a product of fuel cost per lb of fuel and fuel spent in a period; maintenance cost is a product of maintenance cost per an hour and hours in a period; and the fixed operating cost is a product of an operating cost incurred per lb of fuel and fuel spent in the period.

7. The process of claim 1, further comprising constructing a data base of a plurality of profit per factored hour relationships for incremental time intervals, where a factored hour is life spent of the energy producing unit when the unit is fired for an actual hour.

8. The process of claim 1, further comprising constructing a data base of a plurality of profit per factored hour relationships for incremental time intervals, where a factored hour is life spent of the energy producing unit when the unit is fired for an actual hour; selecting a time period for operating the energy producing unit; sequentially selecting factored hours associated with change in profit in descending order according to decreasing change in profit; and transforming the selected factored hours to a firing temperature profile according to inverse functions of a parts life data model.

9. The process of claim 1, further comprising constructing a data base of a plurality of profit per factored hour relationships for incremental time intervals, where a factored hour is life spent of the energy producing unit when the unit is fired for an actual hour; selecting a time period for operating the energy producing unit; sequentially selecting factored hours associated with change in profit in descending order according to decreasing change in profit; transforming the selected factored hours to a firing temperature profile according to inverse functions of a parts life data model; and firing a gas turbine according to the firing temperature profile.

10. The process of claim 1, further comprising constructing a data base of a plurality of profit per factored hour relationships for incremental time intervals, where a factored hour is life spent of the energy producing unit when the unit is fired for an actual hour; selecting a time period for operating the energy producing unit; sequentially selecting factored hours associated with change in profit in descending order according to decreasing change in profit; transforming the selected factored hours to a firing temperature profile according to inverse functions of a parts life data model; firing a gas turbine according to the firing temperature profile; updating the data base at a next time period and recalculating a current firing temperature profile to control the turbine in the next time period.

11. A predictive control process for controlling operation of a turbine engine through actuators that have a defined constraint set according to profit determined from a plurality of power output states and operating cost states; comprising:
(A) constructing a data base by determining a plurality of profit per factored hour relationships for incremental time intervals based on models defined by a relationship:
Prfᵢ(Pᵢqᵢ(fᵢ)−C^{f}F_{flow}(fᵢ)−C^{m}fᵢ−Cᵢ^{o})
where Prfᵢ is profit in period i; Pi is price per mega watt hour in period i; qᵢ is mega watt hours produced in period i; fᵢ is factored hours spent in period i; C^{f} is fuel cost per lb of fuel used; F_{flow} is fuel spent in period i; C^{m} is maintenance cost per factored hour and Cᵢ^{o} is other operating costs incurred in time period i;
and further where at least one data model value is substituted for an operating cost value in the relationship to transform the solution of the relationship to a linear problem solution;
(B) calculating changes in profit from one incremental time interval to a next for the plurality and calculating changes in factored hours from the incremental time interval to the next for each associated profit change;
(C) identifying a maximum change in profit from the calculated changes for the plurality;
(D) determining a firing temperature profile from an inverse function of a factored hour change associated with the identified profit change; and
(E) adjusting the actuators according to the firing temperature profile to control the turbine engine to optimize profit.

12. The process of claim 11, additionally comprising determining operating revenue from product of (Pi) and a value from an operating revenue model value (qi(fi).

13. The process of claim 11, where the at least one data model value substituted for an operating cost value is factored hours.

14. The process of claim 11, where constructing the data base (A), comprises:
(i) finding fᵢ i from a gas turbine performance data model, by numerical inversion from an NOₓ emission constraint;
(ii) inputting ambient temperature, electricity price and fuel cost price for fᵢ=fᵢ to \overline{f}ᵢ by step Δf;
(iii) Converting fᵢ to tᵢ by applying an inverse function relationship from a gas turbine performance data model;
(iv) determining qᵢ(tᵢ) from a gas turbine performance data model; and
(v) calculating Prfᵢ=(Pᵢqᵢ(fᵢ)−C^{f}F_{flow}(fᵢ)−C^{m}fᵢ−Cᵢ^{o}) for a plurality of time periods to produce the data base.

15. The process of claim 11, comprising determining the firing temperature profile and adjusting the actuators according to the profile for a first period i and repeating the steps of determining optimized profit at a beginning of a sequential period i+n and adjusting the actuators for the sequential period i+n.

16. An optimally operated energy producing unit, comprising:
(A) a combustor, and
(B) a controller that regulates firing temperature of the combustor for a time period, wherein a firing temperature is determined as an inverse function of a factored hour associated with an optimal profit for the time period;
wherein the optimal profit is determined as a summation over a period of time of a difference between return from operation of the energy producing unit and cost of operating the energy producing unit, wherein the cost includes at least one non-linear variable and at least one value for the non-linear variable is provided from a data model.

17. A controller for determining an optimal profit for a time maintenance interval and actuating an energy producing unit according to operational parameters, comprising:
a computer readable medium having a computer program stored thereon; the computer program being adapted to summing over a period of time a difference between return from operation of the energy producing unit and cost of operating the energy producing unit to provide a firing temperature profile, wherein the cost includes at least one non-linear variable and at least one value for the non-linear variable is provided from a data model; and
an actuator operating the energy producing unit according to the firing temperature profile derived from the optimal profit.
